(19) United States
(12) Patent Application Publication
(10) Pub. No.: US 2009/0182498 A1
(43) Pub. Date: Jul. 16, 2009

(54) Systems and Methods to Provide Navigational Assistance Using an Online Social Network

(75) Inventor: Leslie G. SEYMOUR, Barrington, IL (US)

Correspondence Address: GREENBERG TRAURIG, LLP (SV3), IP DOCKETING, 2450 COLORADO AVENUE SUITE 400E, SANTA MONICA, CA, 90404, US

(73) Assignee: MAGELLAN NAVIGATION, INC., Santa Clara, CA (US)

(21) Appl. No.: 12/013,384

(22) Filed: Jan. 11, 2008

(51) Int. Cl. G01C 21/34

(52) U.S. Cl. 701/201

(57) ABSTRACT

Systems and methods to provide navigation assistance and user content sharing via an online social network. In one embodiment, a method implemented in a data processing system, includes: receiving user data content tagged with navigational information, from a plurality of users of an online social network; receiving a request from a first user of the online social network to navigate between a starting location and an ending location; and in response to the request, calculating a navigation route between the starting location and an ending location using the user data content tagged with the navigational information.

### FIELD OF THE TECHNOLOGY

At least some embodiments disclosed herein relate to navigation systems in general, and more particular but not limited to, computation of navigational routes.

### BACKGROUND

Navigation solutions have advanced recently. The conventional navigation systems were designed to compute a route, to give driving instructions, and to guide their users to their destinations in geographical areas, which may be unknown or unfamiliar to the users.

Recently, consideration of road conditions, such as construction and traffic jams, led to a dynamic approach to navigation. Even on the way to familiar destinations in a familiar area, information about the traffic situation and the estimated arrival time are generally of interest to users.

Some portable navigation systems have been developed as a travel companion. The navigation system may take the current traffic situation into account when guiding their users in driving, recognize alternative routes, help the user find the way to the destination, and provide information about nearby sights and events.

Internet provides a convenient way to access navigational information, such as online maps. People can use further Internet to communicate with each other, share information, and organize virtual communities.

A social network represents a social structure in which a network of nodes can be used to represent a network of individuals or organizations and the connections between the nodes in the network represent the direct social connections. Web sites can be used to register the social connections of members of a social network and provide features such as automatic address book updates, viewable profiles, services to introduce members to each other to make new social connections, etc. Some Internet social networks are organized around business connections; and some Internet social networks are organized around common interests.

### SUMMARY OF THE DESCRIPTION

Systems and methods to provide navigation assistance and user content sharing via an online social network are described herein. Some embodiments are summarized in this section.

In one embodiment, a method implemented in a data processing system, includes: receiving user data content tagged with navigational information, from a plurality of users of an online social network; receiving a request from a first user of the online social network to navigate between a starting location and an ending location; and in response to the request, calculating a navigation route between the starting location and an ending location using the user data content tagged with the navigational information.

The disclosure includes methods and apparatuses which perform these methods, including data processing systems which perform these methods, and computer readable media containing instructions which when executed on data processing systems cause the systems to perform these methods.

Other features will be apparent from the accompanying drawings and from the detailed description which follows.

### BRIEF DESCRIPTION OF THE DRAWINGS

The embodiments are illustrated by way of example and not limitation in the figures of the accompanying drawings in which like references indicate similar elements.

FIG. 1 shows an example of displaying a navigational route determined according to one embodiment.

FIG. 2 shows a system to determine a navigational route according to one embodiment.

FIG. 3 shows an example of a user interface to share user data content tagged with navigational information according to one embodiment.

FIG. 4 shows an example of sharing user data content during the display of a navigational route determined according to one embodiment.

FIG. 5 shows a block diagram of a data processing system which can be used in various embodiments.

FIG. 6 shows a block diagram of a user device according to one embodiment.

FIG. 7 shows a method to provide navigational assistance according to one embodiment.

### DETAILED DESCRIPTION

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

At least one embodiment of the disclosure uses navigational information and/or user data content shared among the users of an online social network to assist the computation of navigation routes. The use of the information shared through the social network allows the system to compute the navigation solution in an automated, personalized way. The preferences of the users and the recommendations of their friends in the social network are considered in selecting the navigation routes. Further, the user contents tagged with the navigational information can be selective presented via the display of the navigation routes, providing a new, integral way to share user contents and navigational information.

In one embodiment, the social network includes a database that contains data representing the relations between a set of members. In a social network, a member may be represented by a node; and a direct relation between two members is represented by a connection. After the direct relations between members are specified, the database can be used to determine the relations between members that are indirectly connected. For example, the member may identify a friend's friend via the service of the database.

In one embodiment, the number of connections along the shortest path in the social network between two members is considered the degree of separation between the two members. There may be more than one shortest path between the two members.

In one embodiment, the database of the social network further includes information about the members, which are considered the profile data of the members.

For example, a member may edit his/her profile data via the user interface provided by the online social network. The profile data can include various information, such as the name of the member, the location of the member, the personal and/or business interest of the member, the website of the member, the education experiences of the member, etc.

In one embodiment, at least part of the profile data is public; and the public profile data is visible to other members and/or non-members. In one embodiment, the member may specify a setting to selectively classify certain information as private profile data; and the access to the private profile data is limited according to a set of rules.

In one embodiment, the navigation information and/or user data content are shared between friends (e.g., within one degree of separation in the social network). In another embodiment, the user can specify a social distance such that the user data content and/or the navigation information is shared by users who are within the specified social distance from the user in the social network. In one embodiment, the user can specify different social distance for sharing different user data content tagged by the navigation information.

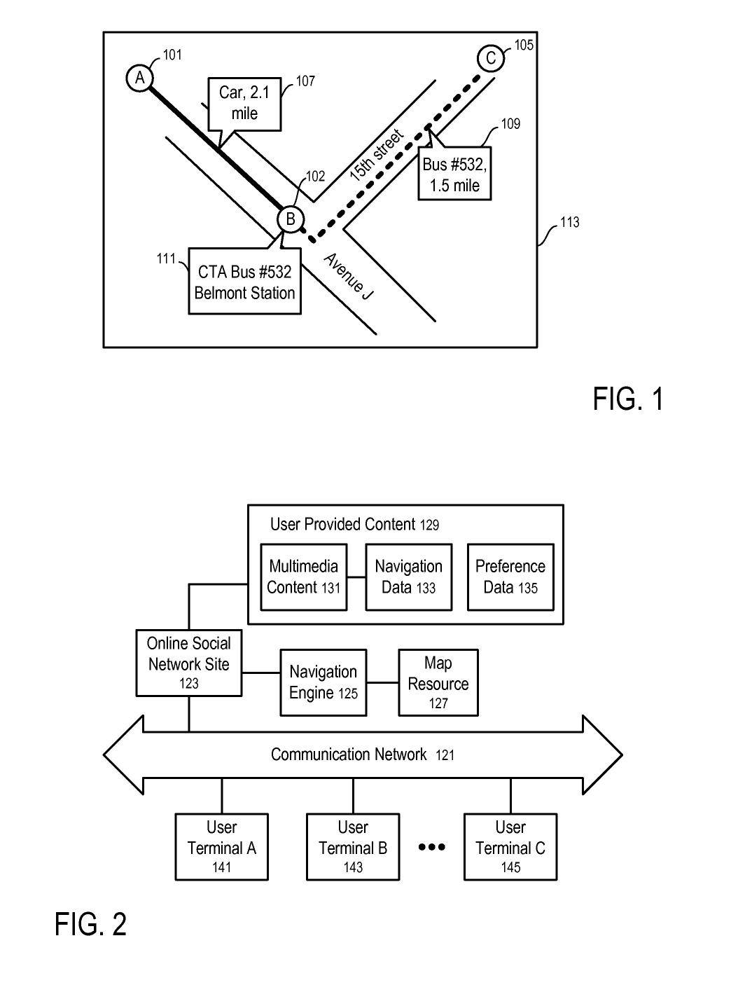

FIG. 1 shows an example of displaying a navigational route determined according to one embodiment. In FIG. 1, after the user specifies the starting location (101) and the ending location (105), the data processing system computes and presents a hybrid navigation route, based on information sharing by the users of an online social network.

In FIG. 1, the computed navigation route includes a transition point (102). The user is instructed to drive (107) for a portion of the route to reach the transition point, and then switch (111) from driving to riding a bus, and ride (109) the bus to complete another portion of the route.

In one embodiment, the selection of the transition point (or a portion of the route) is based on the navigational information shared by the friends of the user in an online social network.

A navigation route can be computed to include one or more transition points along the route. At a transition point the user may be instructed to change the transportation mode. For example, the transportation mode may be changed from driving a car to riding a bus or a train, from one bus line to another bus line, from using a private or public transportation vehicle to walking, etc. In one embodiment, the user may stop at the transition point for a period of time for purposes such as entertainment, sightseeing, rest, food, lodging, etc. and then continue in the same transportation mode, or in a different transportation mode.

A navigation system may compile a database of potential transition points and exclusion objects for the computation of a route. However, manual selection of transition points and exclusion objects from such a database may be difficult for the user, since the user may not know or familiar with the area. In some instances, the user may want a passive navigation solution without actively involving in making selections.

However, proper selection of transition point for hybrid navigation can increase customer satisfaction, especially for route segments where the user may engage in activities other than traveling. For example, at a transition point the user may have to get out of the car, wait for the bus, etc.

In one embodiment, the explicit or implicit recommendations of friends in the social network are used to facilitate the automated selection of the options for the user, or and/or to filter the options for the user. The recommendations may be to include a location or a route segment in a calculated route, or to route through a geographic area, or to exclude a location or a route segment in a calculated route, or to avoid routing through a particular geographic area. Thus, the computed navigation solution is more satisfactory and/or more interesting to the user.

In one embodiment, user data content shared in an online social network is tagged with navigational information, such as locations traveled, exclusion, transition point selection, route segment selection, etc.

For example, the user device of a social network can be integrated with the functionality to tag user content data with navigational information, such as transition point selection made in route calculation, selection of exclusion target objects, route segment selection, geo-cache finding cue, etc. The user data content can be shared with friends and/or other members and jointly enhanced via the online social network.

The social network system stores and updates the information about the uses and references to the navigational information, which is encapsulated in user data content created and offered for sharing by the providing users. The navigational information can be recommended by the social network system (e.g., as transition points) to other receiving users who have similar preferences as the provider users.

In one embodiment, the system performs matching based on user preferences and pre-defined rules. Thus, the providing users do not have to explicitly indicate the recipients of the shared information; and the receiving users do not have to annotate other people's contents for consumption. The social network system can process the preference match to provide the recommendation.

FIG. 2 shows a system to determine a navigational route according to one embodiment. In FIG. 2, the user terminals (e.g., 141, 143, . . . , 145) are used to access an online social network site (123) over a communication network (121).

The online social network site (123) may include one or more web servers (or other types of data communication servers) to communicate with the user terminals (e.g., 141, 143, . . . , 145).

The online social network site (123) is connected to a data storage facility to store user provided content (129), such as multimedia content (131), navigation data (133), preference data (135), etc. The multimedia content (131) is associated with the navigation data (133) to provide a navigational context of the multimedia content (131).

In FIG. 2, a navigation engine (125) is connected to the online social network site (123) to provide navigation solutions to the user terminals (e.g., 141, 143, . . . , 145), using the map resource (127). In one embodiment, the general map resource (127) is not specifically customized for a particular user.

In FIG. 2, the users may use the terminals (e.g., 141, 143, . . . , 145) to make implicit or explicit navigation recommendations. For example, when planning a trip using the navigation engine, a user terminal may be used to manually select a transition point; the user terminal may be used to manually select a route from a plurality of alternative routes presented by the navigation engine; the user terminal may be used on the trip to provide real time guidance and collect data related to the navigation, such as the time period the user spent on a transition point, a preferred alternative route actually used by the user, etc. The user selections can be used as implicit recommendations. The user may also explicitly recommend certain locations and routes with or without additional multimedia content, such as a still picture or a video clip taken at the recommended location, a text message or a sound clip to introduce the location, etc.

In one embodiment, the user terminal (e.g., 141, 143, . . . , 145) can also be used to submit multimedia content (e.g., 131) tagged with the navigation data (133). For example, in one embodiment, the user terminal includes a digital still picture camera, or a digital video camera. At a transition point, the user terminal can be used to create multimedia content for sharing with friends in the online social network. In such an embodiment, the multimedia content can be tagged with the navigation data in an automated way.

Alternatively, the multimedia content can be created using a separate device and loaded into the online social network using the user terminal (e.g., 141, 143, . . . , 145). The users may manually tag the multimedia content with navigational data. For example, the user terminal can be used to associate the user data content with locations and/or routes identified by the navigation engine (125).

Although FIG. 2 illustrates an example system implemented in client server architecture, embodiments of the disclosure can be implemented in various alternative architectures.

For example, the online social network can be implemented via a peer to peer network of user terminals, where the multimedia content and the navigation data are shared via peer to peer communication connections.

For example, navigation engines may be implemented in the individual user terminals, instead of running on one or more centralized servers.

In some embodiments, a combination of client server architecture and peer to peer architecture can be used, in which one or more centralized server may be used to provide some of the information and/or services and the peer to peer network is used to provide other information and/or services. For example, a centralized server can be used to perform user preference matching and select transition point candidates, while transition point selection resolution and route calculation can be performed in the mobile client. For example, the transition point candidates can be provided via the centralized server, while multimedia user content can be provided via peer to peer network connections. Thus, embodiments of disclosure are not limited to a particular architecture.

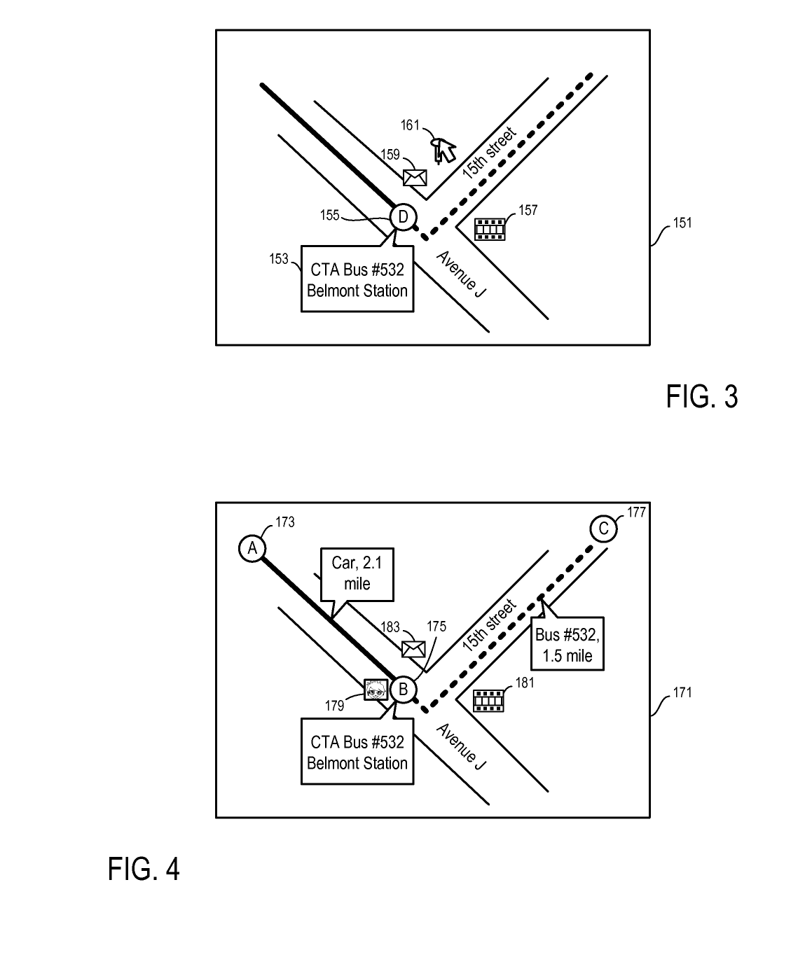

FIG. 3 shows an example of a user interface (151) to share user data content tagged with navigational information according to one embodiment. In FIG. 3, the user manually selects a transition point (155) in seeking a navigation solution, or accepts the instruction (153) to make a transition in an actual trip. The activity of the user provides an implicit or explicit recommendation for friends of the user who share similar interests with the user.

In FIG. 3, the user may provide multimedia content, such as a message (159), a video clip (157), etc., for sharing with friends in the online social network. The user may specifically recommend some locations of interests (e.g. 161) via a selection on the map. The user contents are then associated with the navigational information. In one embodiment, a cluster of recommended locations can be used to identify a recommended local area; and a transition point in the recommended local area, or a route segment going through the recommended local area, can be identified as being recommended.

In other examples, the user may select and view the multimedia content provided by his/her friends. The selection or the lack of the selection of the objects near the transition point (155) provides an indication of recommending or not recommending the transition point (155) for friends of similar interest. Thus, the implicit or explicit recommendation by the user can be used in ranking transition point candidates for friends of the user.

In one embodiment, a user may reject a route suggested by the navigation system. The rejection can be considered as a recommendation to avoid the route or transition point.

In one embodiment, a user may repeatedly avoid a route suggested by the navigation system and consistently using an alternative route. Such a pattern of practice can be identified by the system and used to determine recommended routes and non-recommended routes.

FIG. 4 shows an example of sharing user data content during the display of a navigational route determined according to one embodiment. In FIG. 4, after the transition point (175) is selected based on the implicit or explicit recommendation by a friend of the user (such as the person who used the user interface illustrated in FIG. 3 to make the recommendation via information sharing in an online social network), the navigation route between the starting location (173) and the ending location (177) is presented, together with selected multimedia content provided by the friend for sharing, such as a message (183) and a video clip (181).

In FIG. 4, a graphical representation (179) of the friend who recommended the transition point is also presented (e.g., near the transition point) in the user interface (171). Thus, the user can select the graphical representation (179) for more information about the friend. For example, the icon (179) can be selected to request a profile page of the friend, to view a list of other content provided for sharing by the friend, etc.

In one embodiment, multimedia content shared via the social network can be selectively presented in an automated way during the presentation of the navigation route. For example, an audio or video clip can be presented when the user is guided by the navigation system to a location closer to the transition point. A shared text message can be presented as part of voice guidance of the navigation system.

Various user preference criteria can be used to select navigation recommendations for a user. A navigation recommendation may be based on an implicit or explicit recommendation to use a transition point or navigation route segment, or an implicit or explicit recommendation to avoid a transition point, a navigation route segment, or a geographic area.

For example, user preference criteria may include a requirement that the provider of the recommendation is in a preference buddy-list of the user (or within a predetermined social distance from the user). The user preference criteria may include a requirement that a person in the preference buddy-list of the user (or within a predetermined social distance from the user) has actually used it as a transition point, or have used it more than a predetermined number of times (e.g., used it repeatedly). The user preference criteria may include a requirement that a person in the preference buddy-list of the user (or within a predetermined social distance from the user) has stayed in the surrounding of the transition point for more than a predetermined time period (e.g., a predetermined number of minutes in the surrounding of the transition point during an actual trip guided by the navigation system). For example, the user preference criteria may include a requirement that the areas and segments around the transition point were not excluded later by the person who made the recommendation. The user preference criteria can be used to include certain locations or route segments in a navigation solution, or to exclude certain locations or route segments from a navigation solution.

In one embodiment, the user preference criteria are configurable, pluggable, and tunable by the user. For example, the user may select a set of criteria from a set of pre-defined criteria, or add a custom designed criterion, or adjust the parameters of the selected criteria. Thus, the users can configure the matching process to obtain the desired recommendations from friends via the operation of the online social network.

In one embodiment, the navigation route computed not only considering the recommendations by friends in the social network, but also the real-time traffic conditions nearby transition points, such as changes in the schedules of public transportation, line length for taxi cabs, saturation conditions of parking lots, waiting list length at restaurants, etc.

Thus, at least one embodiment of the disclosure provides a need-driven, passive multimedia content sharing system based on navigation solutions, which allows improved, passive, structured browsing of collected multimedia, geography specific content and allows passive context creation for sharable content. For example, recommendations related to areas to avoid can be presented via exclusions, recommendations related to places to visit (e.g., for coffee if have a few minutes) can be presented via transition point selection.

In one embodiment, the social network based recommendations can also be used to support assisted manual browsing and selection of points of transition and/or exclusion. The social network based recommendations can be used to generate a list of candidates and/or to filter the list retrieved from a compiled database of points of transition and/or exclusions.

In one embodiment, the presentation of the navigation route with the user content also provides a platform to serve advertisements of interest to the user and thus generate advertising revenue.

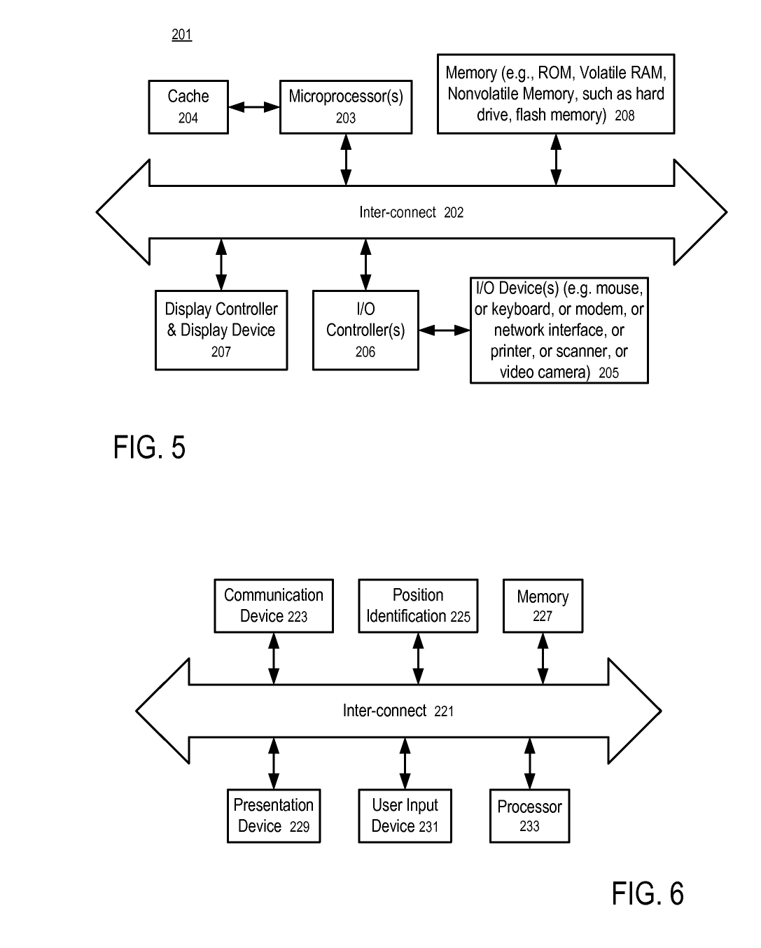

FIG. 5 shows a block diagram of a data processing system which can be used in various embodiments. While FIG. 5 illustrates various components of a computer system, it is not intended to represent any particular architecture or manner of interconnecting the components. Other systems that have fewer or more components may also be used.

In FIG. 5, the system (201) includes an inter-connect (202) (e.g., bus and system core logic), which interconnects a microprocessor(s) (203) and memory (208). The microprocessor (203) is coupled to cache memory (204) in the example of FIG. 5.

The inter-connect (202) interconnects the microprocessor(s) (203) and the memory (208) together and also interconnects them to a display controller and display device (207) and to peripheral devices such as input/output (I/O) devices (205) through an input/output controller(s) (206). Typical I/O devices include mice, keyboards, modems, network interfaces, printers, scanners, video cameras and other devices which are well known in the art.

The inter-connect (202) may include one or more buses connected to one another through various bridges, controllers and/or adapters. In one embodiment the I/O controller (206) includes a USB (Universal Serial Bus) adapter for controlling USB peripherals, and/or an IEEE-1394 bus adapter for controlling IEEE-1394 peripherals.

The memory (208) may include ROM (Read Only Memory), and volatile RAM (Random Access Memory) and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, or an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In one embodiment, a data processing system as illustrated in FIG. 5 is used to implement an online social network site, a navigation engine, and/or other servers, such as a server to match user preferences and/or to select candidates for transition point.

In one embodiment, a data processing system as illustrated in FIG. 5 is used to implement a user terminal, which may receive or compute a navigation route and present the navigation route together with user data content shared via a social network. A user terminal may be in the form of a personal digital assistant (PDA), a cellular phone, a notebook computer or a personal desktop computer.

In some embodiments, one or more servers of the system can be replaced with the service of a peer to peer network of a plurality of data processing systems, or a network of distributed computing system. The peer to peer network, or a distributed computing system, can be collectively viewed as a server data processing system.

Embodiments of the disclosure can be implemented via the microprocessor(s) (203) and/or the memory (208). For example, the functionalities described can be partially implemented via hardware logic in the microprocessor(s) (203) and partially using the instructions stored in the memory (208). Some embodiments are implemented using the microprocessor(s) (203) without additional instructions stored in the memory (208). Some embodiments are implemented using the instructions stored in the memory (208) for execution by one or more general purpose microprocessor(s) (203). Thus, the disclosure is not limited to a specific configuration of hardware and/or software.

FIG. 6 shows a block diagram of a user device according to one embodiment. In FIG. 6, the user device includes an inter-connect (221) connecting the presentation device (229), user input device (231), a processor (233), a memory (227), a position identification unit (225) and a communication device (223).

In FIG. 6, the position identification unit (225) is used to identify a geographic location for user content created for sharing. The position identification unit (225) may include a satellite positioning system receiver, such as a Global Positioning System (GPS) receiver, to automatically identify the current position of the user device. Alternatively, an interactive map can be displayed to the user; and the user can manually select a location from the displayed map.

In FIG. 6, the communication device (223) is configured to communicate with an online social network to provide user data content tagged with navigation data. A navigation solution can be computed and presented at least in part via the processor (233) and the presentation device (229).

In one embodiment, the user input device (231) is configured to generate user data content which is to be tagged with the navigation information for sharing. The user input device (231) may include a text input device, a still image camera, a video camera, and/or a sound recorder, etc.

In one embodiment, the user input device (231) and the position identification unit (225) are configured to automatically tag the user data content created by the user input device (231) with the navigation information identified by the position identification unit (225).

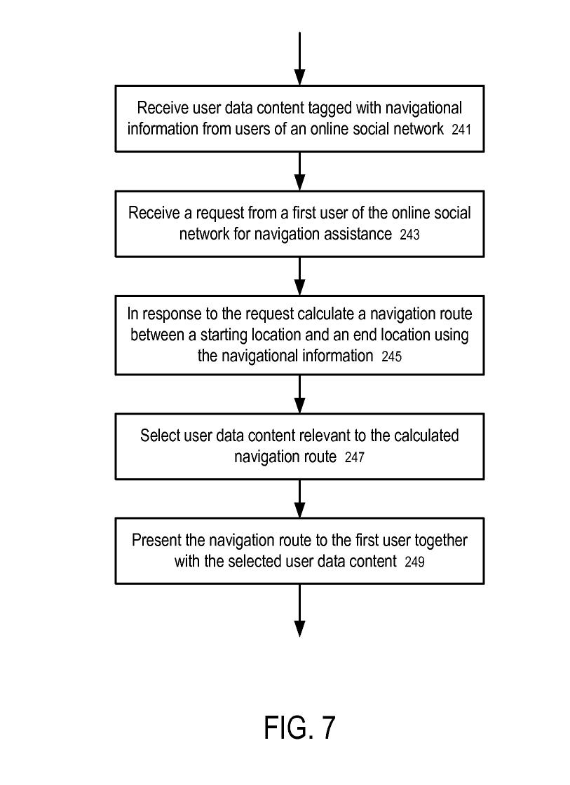

FIG. 7 shows a method to provide navigational assistance according to one embodiment. In FIG. 7, user data content tagged with navigational information is received (241) from a plurality of users of an online social network for sharing. The navigational information may include transition points selected in route calculation, exclusion target objects selected by users of the online social network, route segments selected by users of the online social network, and/or points of interest suggested by users of the online social network.

In FIG. 7, a request is received (243) from a first user of the online social network to navigate between a starting location and an ending location. In response to the request, a navigation route between the starting location and the ending location is calculated (245) using the navigational information shared via the online social network. User data content relevant to the calculated navigation route is selected (247) for the user and presented (249) to the first user together with the navigation route.

In one embodiment, geographic locations identified by users of the online social network are stored; and a geographic location is selected from the stored geographic locations identified by the plurality of users, based on one or more preferences of the first user in the online social network; and the navigation route between the starting location and an ending location is calculated using at least the selected geographic location.

In one embodiment, the selected geographic location is used as a transition point on the navigation route between the starting location and the ending location. For example, the navigation route includes a first transportation mode prior to the transition point and a second transportation mode after the transition point, wherein different vehicles are used in the first transportation mode and the second transportation mode.

In one embodiment, the selected geographic location represents a point of interest at which the first user is expected to stay for a period of time.

In one embodiment, the geographic location is selected based on a social distance between the first user and users who identified the geographic locations in the online social network.

In one embodiment, the geographic location is selected further based on a real time traffic condition, such as public transportation schedule, taxi tab line length, parking lot saturation, and/or a waiting list length.

In one embodiment, the geographic location is selected further based on an experience of a second user who identified the selected geographic location. The experience of the second user may include a stay by the second user at the geographic location for a period of time longer than a threshold, and/or the second user completing a travel along a route through the selected geographic location in an area between the starting location and the ending location.

In one embodiment, time periods of stay by users of the online social network at one or more of the stored geographic locations are recorded using navigational devices of corresponding users, where the recorded time periods are used in the selecting of the geographic location.

In one embodiment, a map is presented to show the navigation route to the first user; and content provided by a second user who identified the selected geographic location in the online social network is also presented with the navigation route. The content can be presented automatically or in response to the first user selecting a representation of the geographic location on the map.

In one embodiment, a portion of the navigational information is selected based on a set of preference criteria of the first user; and the calculated navigation route is based on the selected portion of the navigational information.

In one embodiment, a location or route segment is identified based on a set of preference criteria of the first user; and the navigation route is calculated based on excluding the identified location or route segment from the calculated navigation route.

In this description, various functions and operations may be described as being performed by or caused by software code to simplify description. However, those skilled in the art will recognize what is meant by such expressions is that the functions result from execution of the code by a processor, such as a microprocessor. Alternatively, or in combination, the functions and operations can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system, middleware, service delivery platform, SDK (Software Development Kit) component, web services, or other specific application, component, program, object, module or sequence of instructions referred to as “computer programs.” Invocation interfaces to these routines can be exposed to a software development community as API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The instructions may be embodied in digital and analog communication links for electrical, optical, acoustical or other forms of propagated signals, such as carrier waves, infrared signals, digital signals, etc.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method implemented in a data processing system, the method comprising:
receiving user data content tagged with navigational information, from a plurality of users of an online social network;
receiving a request from a first user of the online social network to navigate between a starting location and an ending location; and
in response to the request, calculating a navigation route between the starting location and an ending location using the user data content tagged with the navigational information.

2. The method of claim 1, further comprising:
selecting user data content relevant to the calculated navigation route; and
presenting the navigation route to the first user together with the selected user data content.

3. The method of claim 1, further comprising:
storing geographic locations identified by users of the online social network; and
selecting a geographic location from the stored geographic locations identified by the plurality of users, based on one or more preferences of the first user in the online social network; and
wherein the navigation route between the starting location and an ending location is calculated using at least the selected geographic location.

4. The method of claim 3, wherein the selected geographic location is used as a transition point on the navigation route between the starting location and the ending location.

5. The method of claim 4, wherein the navigation route includes a first transportation mode prior to the transition point and a second transportation mode after the transition point.

6. The method of claim 5, wherein different vehicles are used in the first transportation mode and the second transportation mode.

7. The method of claim 3, wherein the selected geographic location represents a point of interest at which the first user is expected to stay for a period of time.

8. The method of claim 3, wherein the geographic location is selected based on a social distance between the first user and users who identified the geographic locations in the online social network.

9. The method of claim 8, wherein the geographic location is selected further based on a real time traffic condition.

10. The method of claim 9, wherein the traffic condition comprises at least one of: public transportation schedule, taxi tab line length, parking lot saturation, and a waiting list length.

11. The method of claim 8, wherein the geographic location is selected further based on an experience of a second user who identified the selected geographic location.

12. The method of claim 11, wherein the experience of the second user comprises a stay by the second user at the geographic location for a period of time longer than a threshold.

13. The method of claim 11, wherein the experience of the second user comprises the second user completing a travel along a route through the selected geographic location in an area between the starting location and the ending location.

14. The method of claim 3, further comprising:
recording time periods of stay by users of the online social network at one or more of the stored geographic locations using navigational devices of corresponding users;
wherein the recorded time periods are used in the selecting of the geographic location.

15. The method of claim 3, further comprising:
presenting a map to show the navigation route to the first user; and
presenting content provided by a second user who identified the selected geographic location in the online social network.

16. The method of claim 15, wherein the content provided by the second user is presented in response to the first user selecting a representation of the geographic location on the map.

17. The method of claim 1, wherein the navigational information comprises one or more of: transition points selected in route calculation, exclusion target objects selected by users of the online social network, route segments selected by users of the online social network, and points of interest suggested by users of the online social network.

18. The method of claim 1, further comprising:
selecting a portion of the navigational information based on a set of preference criteria of the first user;
wherein the calculated navigation route is based on the selected portion of the navigational information.

19. The method of claim 1, further comprising:
identifying a location or route segment based on a set of preference criteria of the first user;
wherein the navigation route is calculated based on excluding the identified location or route segment from the calculated navigation route.

20. A machine readable media embodying instructions, the instructions causing a data processing system to perform a method, the method comprising:
receiving user data content tagged with navigational information, from a plurality of users of an online social network;
receiving a request from a first user of the online social network to navigate between a starting location and an ending location; and
in response to the request, calculating a navigation route between the starting location and an ending location using the user data content tagged with the navigational information.

21. A data processing system, comprising:
means for receiving user data content tagged with navigational information, from a plurality of users of an online social network;
means for receiving a request from a first user of the online social network to navigate between a starting location and an ending location; and
means for calculating a navigation route between the starting location and an ending location using the user data content tagged with the navigational information, in response to the request.
